(19) United States
(12) Patent Application Publication
(10) Pub. No.: US 2013/0117682 A1
(43) Pub. Date: May 9, 2013

(54) INFORMATION PROCESSING APPARATUS FOR REMOTE CONTROL OF DEVICE, AND CONTROL METHOD AND STORAGE MEDIUM THEREFOR

(71) Applicant: CANON KABUSHIKI KAISHA, Tokyo (JP)

(72) Inventor: Yusuke Fukasawa, Tokyo (JP)

(73) Assignee: CANON KABUSHIKI KAISHA, Tokyo (JP)

(21) Appl. No.: 13/670,736

(22) Filed: Nov. 7, 2012

(30) Foreign Application Priority Data
Nov. 8, 2011 (JP) 2011-244564

(51) Int. Cl. G06F 3/01

(52) U.S. Cl. 715/740

(57) ABSTRACT

An information processing apparatus capable of easily remote-controlling a device connected thereto through a network. The information processing apparatus, e.g., a PC is installed with a remote control client application in which a display control part causes a display unit of the PC to display a software key screen, and a key operation acceptance part accepts a key operation performed on the software key screen and holds key operation information corresponding to the key operation. The key operation information is converted into transmission data that is transmitted through the network to the device. When the key operation acceptance part accepts a particular key operation, display of a software key button associated with the key operation is changed under the control of the display control part.

### BACKGROUND OF THE INVENTION

1. Field of the Invention

The present invention relates to an information processing apparatus such as a personal computer for remotely controlling a device e.g. a multi-function peripheral, and relates to a control method and a storage medium therefor. In particular, this invention relates to an information processing apparatus capable of displaying a private mode screen on which various settings and the like can be made in private and closed to the public, and relates to a control method and a storage medium therefor.

2. Description of the Related Art

An information processing apparatus or terminal is conventionally known that is capable of displaying a private mode screen on which particular information or the like can be set in private and closed to the public. For example, particular keys of a terminal keyboard are simultaneously pressed to cause the information processing terminal to display the private mode screen on which setting information is set by a terminal manager, thereby preventing the setting information from being changed by a general user. However, there is a fear that the private mode screen is accidentally displayed when the particular keys are simultaneously pressed by accident. To obviate this, a key data processing system has been proposed, in which the private mode screen is displayed on condition that particular keys are pressed in a predetermined pressing order (see, for example, Japanese Laid-open Patent Publication No. H06-149437).

Also known is an information processing apparatus that is capable of remote controlling a multi-function peripheral or other device. By applying to such information processing apparatus the aforesaid key data processing system, it is possible not only to make settings of the information processing apparatus on the private mode screen, but also to make settings of the device on the private mode screen by way of remote control.

However, if the key operation method to cause the information processing apparatus to display the private mode screen differs between remote-controlled devices, the manager must perform the key operation by the method that varies according to device type, resulting in difficulties to perform the key operation.

If the manager is physically handicapped person for whom it is difficult to operate hardware keys, it is preferable that the operation can be easily performed by use of a simple interface device such as a mouse.

It is also preferable that the security can be maintained to prevent an ill-intentioned user from knowing the key operation method and from conducting an unauthorized operation such as modifying the settings.

### SUMMARY OF THE INVENTION

The present invention provides an information processing apparatus capable of easily remote-controlling a device connected thereto through a network, and provides a control method and a storage medium therefor.

According to one aspect of this invention, there is provided an information processing apparatus for remotely operating a device connected thereto through a network, which comprises a display unit, a display control unit configured to cause the display unit to display a software key screen, a key operation acceptance unit configured to accept a key operation performed on the software key screen and hold key operation information corresponding to the key operation, a data conversion unit configured to convert the key operation information into transmission data, a communication unit configured to transmit the transmission data to the device through the network, and a change unit configured to change display of software keys on the software key screen in a case where the key operation acceptance unit accepts a particular key operation that causes the display unit to display a particular screen.

With this invention, the information processing apparatus can easily remote control the device through the software key screen.

Further features of the present invention will become apparent from the following description of an exemplary embodiment with reference to the attached drawings.

### BRIEF DESCRIPTION OF THE DRAWINGS

FIG. 1 is a block diagram showing the internal construction of a PC, which is an example of an information processing apparatus according to one embodiment of this invention, and showing the internal construction of a device;

FIG. 2A is a view showing an example of a menu screen displayed on a display unit of the PC;

FIG. 2B is a view showing an example of a software key screen displayed on the display unit;

FIG. 3A is a view showing an example operation where key buttons are simultaneously pressed on the software key screen;

FIG. 3B is a view showing an example operation where key buttons are successively pressed on the software key screen;

FIG. 4A is a view showing an example operation where a key button is long pressed on the software key screen;

FIG. 4B is a view showing an operation for navigating particular key candidates on the software key screen; and

FIGS. 5A and 5B are a flowchart showing a process performed by the PC and by the device in response mainly to a particular key operation.

### DESCRIPTION OF THE EMBODIMENTS

The present invention will now be described in detail below with reference to the drawings showing a preferred embodiment thereof.

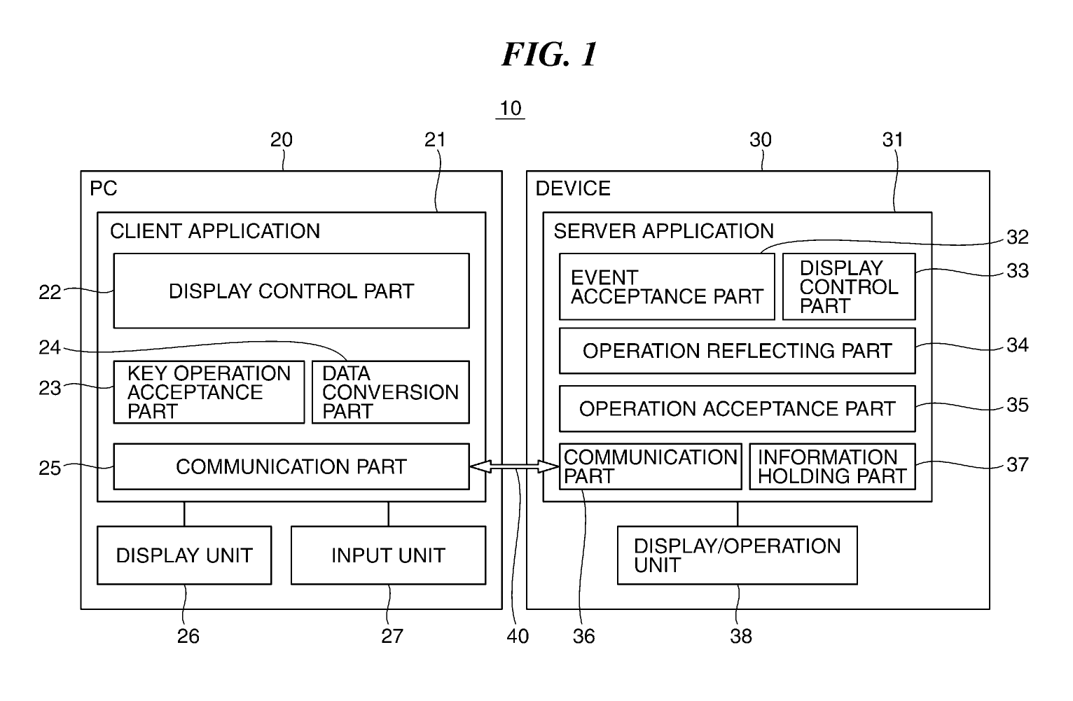

FIG. 1 shows in block diagram, together with the internal construction of a device, the internal construction of a personal computer (hereinafter referred to as the PC), which is an example of an information processing apparatus according to one embodiment of this invention.

In FIG. 1, reference numeral 10 denotes a remote operation system including a PC 20, a device 30, and a network 40 through which the PC 20 and the device 30 are connected with each other. A manager and a PC user can remote control the device 30 by use of the PC 20. A device user can directly operate the device 30.

The PC 20 includes a CPU, a memory device having RAM, ROM, and hard disk, a display unit such as LCD, and an input unit having hardware keyboard and mouse. In FIG. 1, only the display unit and the input unit are denoted by reference numerals 26, 27. It should be noted that the key arrangement of the keyboard and the number of mouse click buttons are not limitative.

The device 30 is e.g. a multi-function peripheral that has a control unit, printer unit, scanner unit, operation/display unit, etc. by which a copy function, scanner function, printer function, fax function, etc. are achieved. In FIG. 1, only the display/operation unit is denoted by reference numeral 38. The display/operation unit 38 includes a touch panel type operation/display part and hardware keys, for instance.

The PC 20 and the device 30 are respectively installed with a remote control client application 21 and a remote control server application 31 between which bi-directional data communication is performed through the network 40.

The client application 21 has function parts each constituted by a software module. More specifically, the client application 21 includes a display control part 22, key operation acceptance part 23, data conversion part 24, and communication part 25.

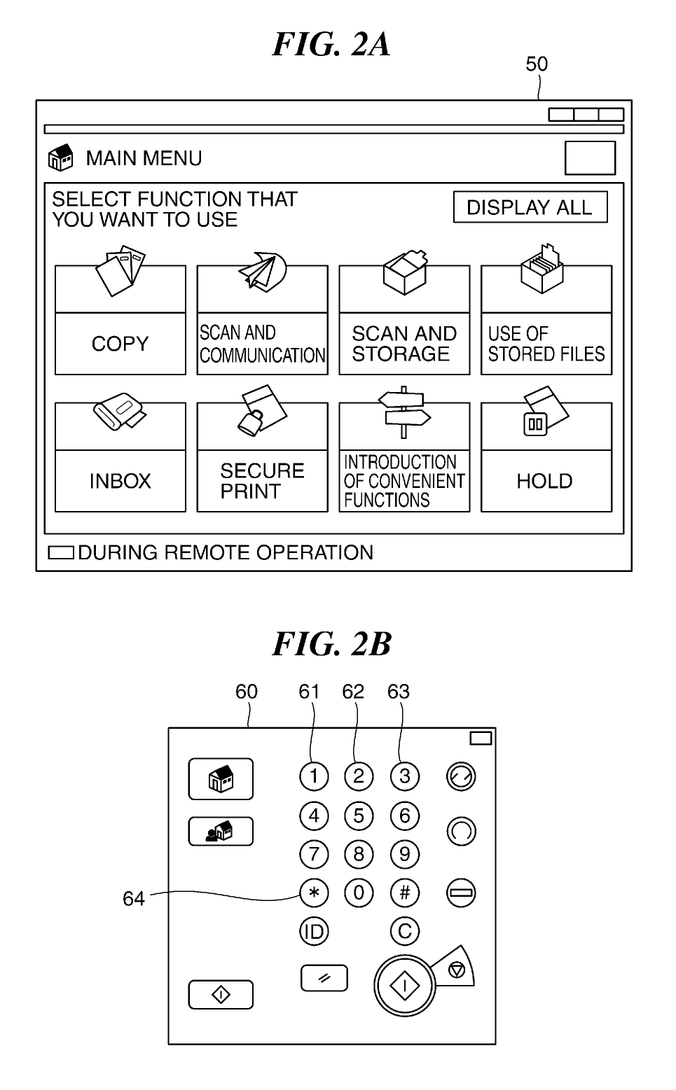

The display control part 22 causes the display unit 26 of the PC 20 to display a menu screen and a software key screen. An example of the menu screen is shown at reference numeral 50 in FIG. 2A, and an example of the software key screen is shown at reference numeral 60 in FIG. 2B. The key operation acceptance part 23 accepts a key operation on the menu screen 50 or on the software key screen 60 through the input unit 27 of the PC 20, and holds key operation information corresponding to the key operation. The data conversion part 24 converts the key operation information into transmission data. The communication part 25 transmits the transmission data to the server application 31 and receives information from the server application 31.

The server application 31 has function parts each constituted by a software module. More specifically, the server application 31 includes an event acceptance part 32, display control part 33, operation reflecting part 34, operation acceptance part 35, communication part 36, and information holding part 37.

The event acceptance part 32 accepts information that is input through hardware keys of the display/operation unit 38 of the device 30. The display control part 33 controls display on the operation/display part of the display/operation unit 38.

The operation acceptance part 35 accepts data input through the software key screen 60, which is displayed on the display unit 26 of the PC 20. The operation reflecting part 34 handles data accepted by the operation acceptance part 35 from the PC 20 in the same manner as data input through the hardware keys of the device 30. For example, when the software key button of number “1” (see FIG. 2B) is pressed on the software key screen 60, the operation acceptance part 35 performs the same processing as that performed when the hardware key of number “1” is pressed on the device 30.

The communication part 36 performs bi-directional communication with the communication part 25 of the client application 21, to thereby transmit information held in the information holding part 37 to the PC 20 and receive transmission data from the PC 20.

As will be described in detail later, the PC 20 is configured to be capable of causing the display unit 26 to display a particular screen (private mode screen) on condition that a particular key operation is performed. Accordingly, in a case for example that the manager sets various setting information of the PC 20 or sets various setting information of the device 30 by way of remote control from the PC 20 through the network 40, the security can be maintained by making setting operations on the particular screen in a state invisible from a general user.

Next, a description will be given mainly of a particular key operation, which is performed by the manager or other person on the software key screen 60 displayed on the display unit 26 of the PC 20 in order to cause the display unit 26 to display the particular screen.

As shown in FIG. 2B, software keys such as software key buttons of number “0” to “9” and of symbol asterisk (*), ID, and C (hereinafter referred to as the key buttons) are displayed on the software key screen 60. In FIG. 2B, reference numerals 61 to 64 denote the key buttons of number “1” to “3” and of symbol asterisk (*), respectively.

In this embodiment, the particular key operation is performed by simultaneously pressing key buttons or by successively pressing key buttons or by long-pressing a key button, but this is not limitative. Simultaneous key button pressing and/or successive key button pressing and/or long button pressing can be performed in combination, and any other particular key operation can also be performed.

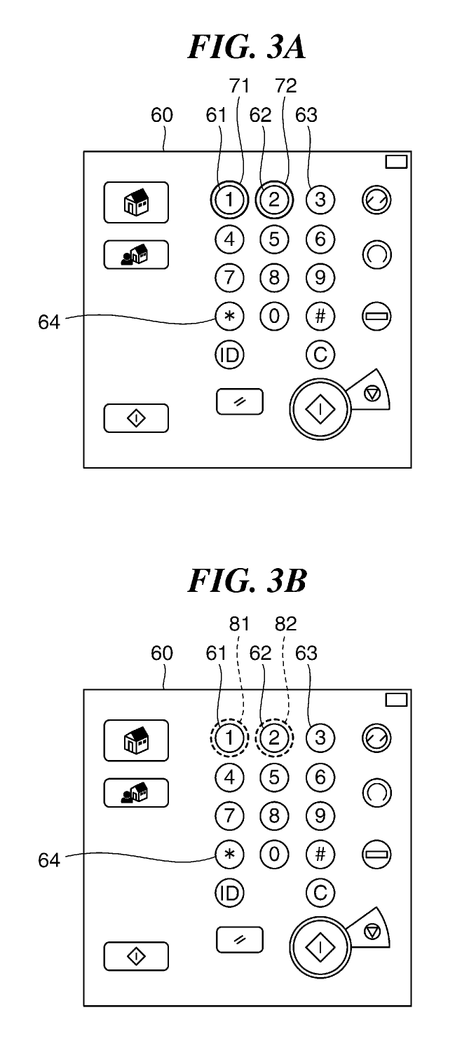

First, with reference to FIG. 3A, a description will be given of an example operation where the manager simultaneously presses the key buttons 61 to 63 of number “1” to “3” on the software key screen 60.

In this example operation, the manager sequentially clicks the key buttons 61, 62 with right mouse button in order to perform the particular key operation on the key buttons 61, 62. In response to this, the display control part 22 marks the key buttons 61, 62 as shown at reference numerals 71, 72 in FIG. 3A. The term “marking” refers to that the color or shape of the key button concerned is changed or the color or shape of the surrounding of the key button is changed. At the markings 71, 72 in the illustrated example, the key buttons 61, 62 are each surrounded by a circle mark. Alternatively, it is possible to change the shape of the key buttons 61, 62 from circle to square or to triangle, for example.

Next, when the manager clicks the key button 63 with left mouse button in order to perform an ordinary key operation on the key button 63, the display control part 22 cancels the markings 71, 72. The marking cancellation represents the completion of operations. The key operation acceptance part 23 accepts the above series of operations, and holds key operation information representing the series of operations. The data conversion part 24 determines, based on the key operation information, that the three key buttons 61 to 63 have simultaneously been pressed, and converts the key operation information into transmission data representing that the key buttons 61 to 63 have simultaneously been pressed. The communication part 25 transmits the transmission data to the communication part 36 of the server application 31.

As described above, in a case where the particular key operation is performed (e.g., right mouse buttons are sequentially clicked) and then the ordinary key operation is performed (e.g., left mouse button is clicked), the display control part 33 causes the display/operation part of the display/operation unit 38 to display the private mode screen on which a text box for PIN entry is displayed, for example. When a PIN is input into the text box, a menu for selecting a setting screen or the like is displayed.

In the example operation, the simultaneous key button pressing is determined when key buttons are sequentially mouse clicked on the software key screen 60, but this is not limitative. Alternatively, it is possible to determine the simultaneous pressing when keys of the keyboard are sequentially pressed, for example.

Next, with reference to FIG. 3B, a description will be given of another example operation where the manager successively presses the key buttons 61 to 63 of number “1” to “3” on the software key screen 60.

In the example operation, the manager double-clicks the key button 61 with left mouse button to perform the particular key operation on the key button 61, and then clicks the key button 62 with left mouse button to perform the ordinary key operation on the key button 62. In response to this, the display control part 22 marks the key buttons 61, 62 as shown at reference numerals 81, 82 in FIG. 3B. Subsequently, when the manager double-clicks the key button 63 to perform the particular key operation on the key button 63, the display control part 22 cancels the markings 81, 82. The marking cancellation represents the completion of operations. The key operation acceptance part 23 accepts the series of operations, and holds key operation information representing the series of operations. The data conversion part 24 determines, based on the key operation information, that the three key buttons 61 to 63 have successively been pressed, and converts the key operation information into transmission data representing that the key buttons 61 to 63 have successively been pressed. The communication part 25 transmits the transmission data to the communication part 36 of the server application 31.

As described above, in a case where the particular key operation is performed (e.g., left mouse button is double-clicked) once, the ordinary key operation is performed (e.g., left mouse button is clicked) at least once, and then the particular key operation is performed (e.g., left mouse button is double-clicked) once again, the display control part 33 causes the display/operation part of the display/operation unit 38 to display the private mode screen.

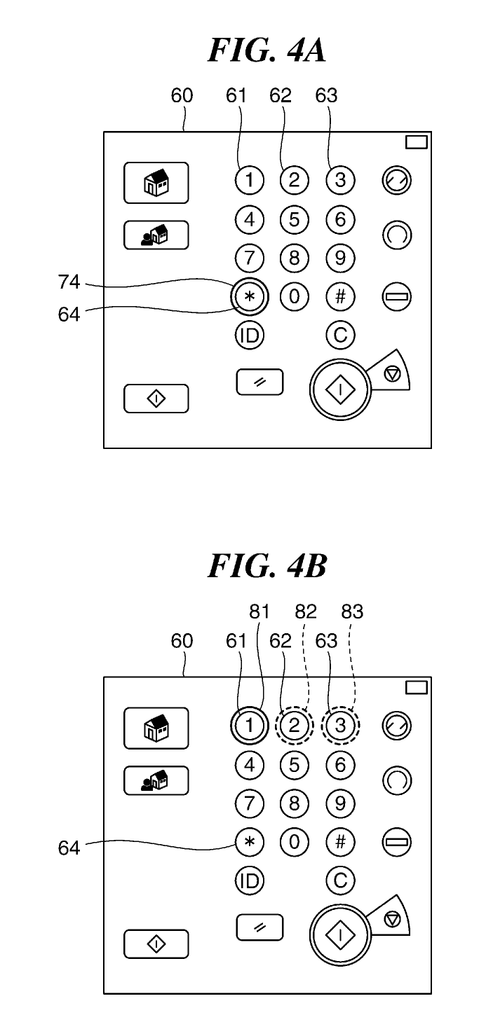

Next, with reference to FIG. 4A, a description will be given of still another example operation where the manager long-presses the key button 64 of symbol asterisk (*) on the software key screen 60.

In the example operation, in order to perform the particular key operation twice on the key button 64, the manager presses the key button 64 with left mouse button and presses the key button 64 with right mouse button in a state where the key button 64 is being pressed with left mouse button. In response to this, the display control part 22 marks the key button 64 as shown at reference numeral 74 in FIG. 4A. Subsequently, when the left and right mouse button depressions are released, the display control part 22 cancels the marking 74. The marking cancellation represents the completion of operations. The key operation acceptance part 23 accepts the series of operations, and holds key operation information representing the series of operations. The data conversion part 24 determines, based on the key operation information, that the key button 64 has been long-pressed, and converts the key operation information into transmission data representing that the key button 64 has been long-pressed. The communication part 25 transmits the transmission data to the communication part 36 of the server application 31.

As described above, in a case that the particular key operation is performed (e.g., right mouse button is pressed) once in a state where the particular key operation is being performed (e.g., left mouse button is being pressed), the display control part 33 causes the display/operation part of the display/operation unit 38 to display the private mode screen.

Next, with reference to FIG. 4B, a description will be given of a process to navigate particular key candidates . In this embodiment, in order to assist the manager or other person to perform the particular key operation on the software key screen 60 displayed on the display unit 26, navigation is conducted to display one or more particular key candidates on the software key screen 60 in response to a navigation request operation performed by the manager or other person.

When the manager or other person double-clicks e.g. the key button 61 of number “1” (among the key buttons displayed on the software key screen 60) with right mouse button, in order to perform a navigation request operation (particular key operation) on the key button 61, the key operation acceptance part 23 accepts the navigation request operation and holds key operation information representing the navigation request operation. Based on the key operation information, the display control part 22 marks the key button 61 as shown at reference numeral 81 in FIG. 4B. The data conversion part 24 determines, based on the key operation information, that the navigation request operation has been made, and converts the key operation information into an inquiry about particular key candidates associated with the key button 61. The communication part 25 transmits the inquiry to the communication part 36 of the server application 31.

Pieces of information representing particular key candidates associated with respective ones of the key buttons are held in the information holding part 37 of the server application 31. When the communication part 36 receives the inquiry about particular key candidates associated with the key button 61 from the communication part 25 of the PC 20, the information holding part 37 determines whether information representing one or more particular key candidates associated with the key button 61 is held in the information holding part 37. If it is determined that such particular key candidate information is held in the information holding part 37, the communication part 36 transmits the particular key candidate information to the client application 21.

In the PC 20, the display control part 22 marks one or more key buttons, which are associated with the key button specified in the inquiry (the key buttons 62, 63 associated with the key button 61 in this example), as shown at reference numerals 82, 83 in FIG. 4B based on the particular key candidate information received by the communication part 25 from the communication part 36 of the device 30, whereby the particular key candidates are displayed on the software key screen 60 for navigation to the manager.

As described above, in a case where the particular key operation (navigation request operation) is performed once (e.g., right mouse button is clicked once), the corresponding particular key candidate information is acquired from the information holding part 37 of the server application 31, and one or more key buttons represented by the particular key candidate information are marked for navigation. Accordingly, even if the method of particular key operation varies according to device type, the manager can properly perform the particular key operation in accordance with the navigation, thereby reducing the load on the manager.

As described above, key buttons are simultaneously or successively pressed or a key button is long-pressed to perform the particular key operation. Then, marking is performed based on key operation information, and navigation is conducted based on key candidate information. By using a dedicated tool or an edition tool such as a text editor, the manager or other person is capable of preparing setting information associated with the particular key operation, marking, and navigation (setting information associated with at least the particular key operation) in a manner capable of being added, removed, and modified. The data conversion part 24 of the client application 21 can hold the prepared setting information (hereinafter, referred to as the key setting information), and can convert the key setting information into data that can be interpreted by the server application 31.

In the key setting information, simultaneous key button pressing, successive key button pressing, key button long pressing, marking, navigation, etc. are defined for example as follows:

Simultaneous pressing=Right mouse button clicking: Mark, Left mouse button clicking: Transmission

Successive pressing=Left mouse button double clicking: Start, Left mouse button clicking: Mark, Left mouse button double clicking: Transmission

Long pressing=Left mouse button pressing, Right mouse button pressing: Transmission

Marking=None

Navigation=None

The client application 21 can encrypt the key setting information with arbitrary encryption algorithm and hold the encrypted key setting information. In a case where the encrypted key setting information is used, the client application 21 decrypts the encrypted key setting information, and the data conversion part 24 holds the decrypted key setting information and converts it into data that can be interpreted by the server application 31.

Since the key setting information can be encrypted and managed, it is possible to prevent an ill-intentioned user from performing an unauthorized operation such as modifying the key setting information.

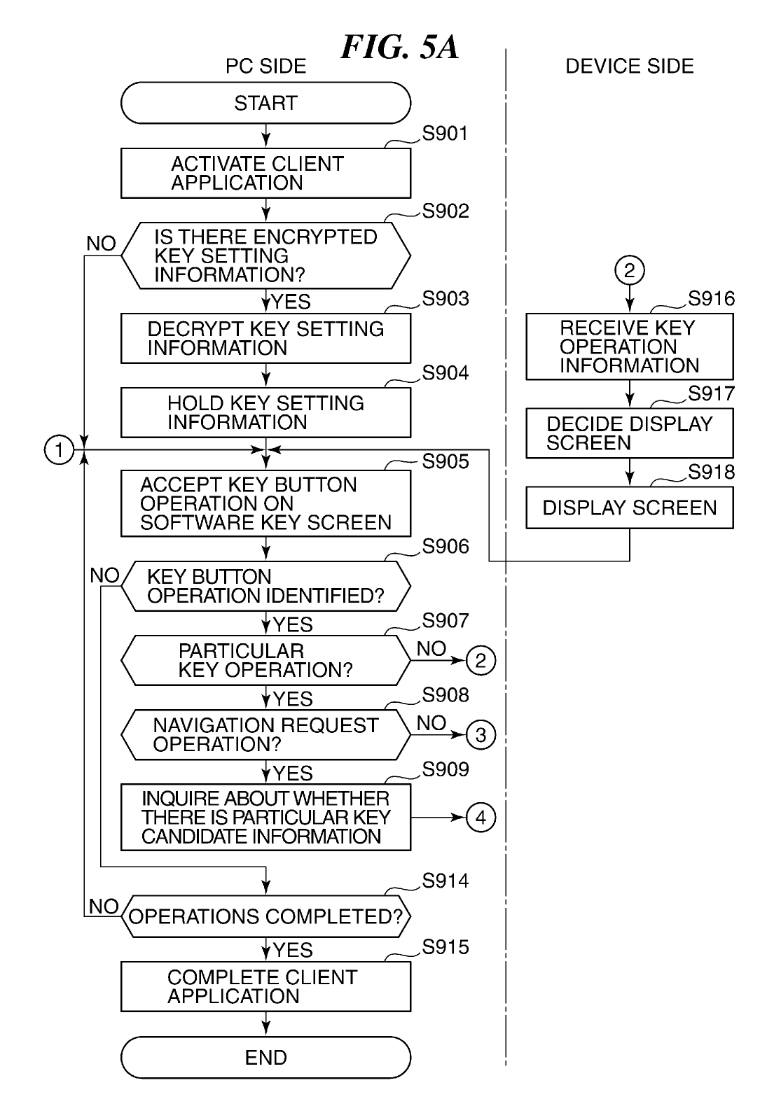

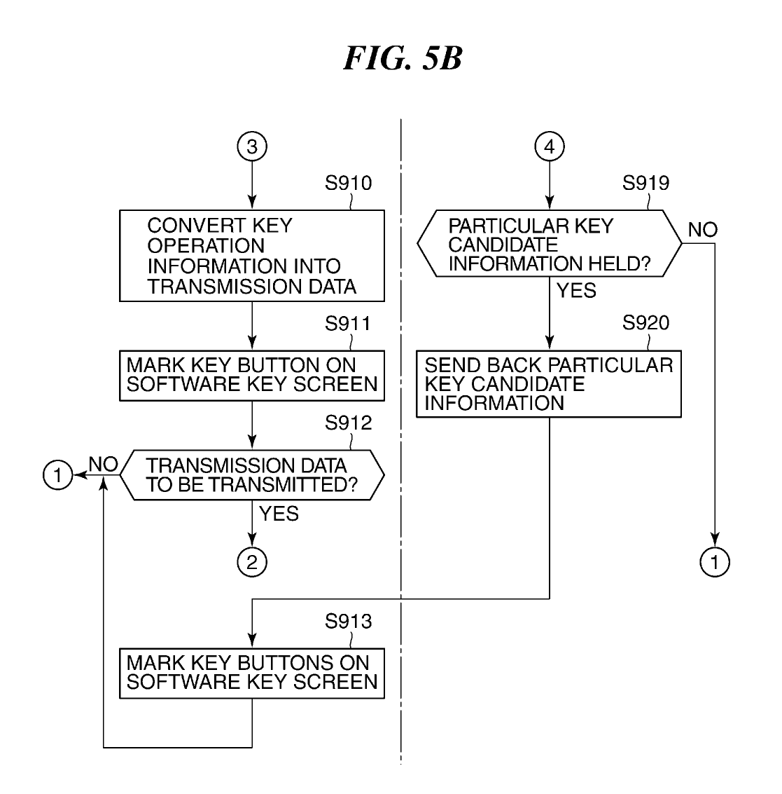

Next, with reference to FIGS. 5A and 5B, a description will be given of a process performed by the PC 20 and the device 30 in response mainly to a particular key operation.

In step S901, the client application 21 is activated. In step S902, whether encrypted key setting information associated with at least the particular key operation is held in the client application 21 is determined. If the answer to step S902 is YES, the flow proceeds to step S903 where the key setting information is decrypted. The decrypted key setting information is held in the data conversion part 24 (step S904).

On the other hand, if it is determined in step S902 that encrypted key setting information is not held in the data conversion part 24, the flow proceeds to step S905 where the key operation acceptance part 23 accepts a key button operation performed on the software key screen 60. Next, the key operation acceptance part 23 determines whether a key button operation has been identified (step S906). To this end, the key operation acceptance part 23 analyzes the key operation performed on the software key screen 60, and identifies what operation is performed on which of key buttons. If no key operation has been identified in step S906 (for example, if no key operation has been performed before lapse of a predetermined time period or if an ineffective operation has been performed), the flow proceeds to step S914.

On the other hand, if the key operation has been identified in step S906, the key operation acceptance part 23 determines based on the key setting information held in the data conversion part 24 in step S904 whether the identified key operation is a particular key operation (step S907). If it is determined in step S907 that the identified key operation is a particular key operation, the key operation acceptance part 23 determines whether the particular key operation is a navigation request operation (step S908). If the answer to step S908 is YES, the communication part 25 inquires of the device 30 about whether there is particular key candidate information corresponding to the key button associated with the navigation request operation (step S909).

In the device 30 that has received the inquiry, the server application 31 determines whether particular key candidate information is held in the information holding part 37 (step S919). If the answer to step S919 is NO, the flow proceeds to step S905.

On the other hand, if it is determined in step S919 that particular key candidate information is held in the information holding part 37, the communication part 36 sends the particular key candidate information back to the PC 20 (step S920). In the PC 20, the display control part 22 of the client application 21 marks one or more key buttons on the software key screen 60 that correspond to the sent back particular key candidate information (step S913). Then, the flow returns to step S905.

If it is determined in step S908 that the key operation identified in step S906 is not a navigation request operation, the data conversion part 24 converts key operation information corresponding to the key button operation accepted in step S905 into transmission data that can be interpreted by the device 30 (step S910). The display control part 22 marks a key button on the software key screen 60 corresponding to the key operation information (step S911), and determines based on the key operation information whether the transmission data is to be transmitted to the device 30 (step S912). If the answer to step S912 is YES, the flow proceeds to step S916. On the other hand, if the answer to step S912 is NO, the flow returns to step S905.

If it is determined in step S907 that the key operation identified in step S906 is not a particular key operation, the flow proceeds to step S916. In the device 30, the communication part 36 receives the key operation information, and the operation acceptance part 35 accepts the key operation information. Then, the operation reflecting part 34 decides a display screen which is similar to that to be used in a case where a hardware key on the device 30 corresponding to the key button on the software key screen 60 represented by the key operation information is pressed (step S917), and the display control part 33 causes the display/operation part of the display/operation unit 38 to display the decided screen (step S918). Subsequently, the flow proceeds to step S905.

In step S914, the client application determines whether operations are completed. If the answer to step S914 is NO, the flow returns to step S905. On the other hand, if the answer to step S914 is YES, the client application 21 is completed (step S915), whereupon the present process is completed.

With this embodiment, when receiving the particular key operation, the client application 21 marks the software key associated with the particular key operation to thereby change the manner of display of the software key, whereby the manager or other person becomes capable of easily conducting the particular key operation and the load in conducting the key operation can be reduced.

Since the key setting information can be changed and can be encrypted and managed, it is possible to prevent an ill-intentioned user from performing an unauthorized operation such as changing various settings.

It should be noted that a case has been described in the above embodiment where the key setting information is encrypted and the navigation is conducted to display particular key candidates on the software key screen 60. However, it is not inevitably necessary to encrypt the key setting information and to conduct the navigation. In other words, steps S902 to S904 and steps S908 to S920 in FIG. 5 can be omitted.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2011-244564, filed Nov. 8, 2011, which is hereby incorporated by reference herein in its entirety.

What is claimed is:

1. An information processing apparatus for remotely operating a device connected thereto through a network, comprising:
a display unit;
a display control unit configured to cause said display unit to display a software key screen;
a key operation acceptance unit configured to accept a key operation performed on the software key screen and hold key operation information corresponding to the key operation;
a data conversion unit configured to convert the key operation information into transmission data;
a communication unit configured to transmit the transmission data to the device through the network; and
a change unit configured to change display of software keys on the software key screen in a case where said key operation acceptance unit accepts a particular key operation that causes said display unit to display a particular screen.

2. The information processing apparatus according to claim 1, wherein in a case where the particular key operation is successively performed and then an ordinary key operation is performed, said display control unit causes said display unit to display the particular screen.

3. The information processing apparatus according to claim 1, wherein in a case where the particular key operation is performed once, an ordinary key operation is performed at least once, and then the particular key operation is performed once again, said display control unit causes said display unit to display the particular screen.

4. The information processing apparatus according to claim 1, wherein in a case where the particular key operation is performed once in a state that the particular key operation is being performed, said display control unit causes said display unit to display the particular screen.

5. The information processing apparatus according to claim 1, wherein in a case where the particular key operation is performed once, said change unit acquires key candidate information from the device and changes a manner of displaying a software key represented by the key candidate information.

6. The information processing apparatus according to claim 1, further including:
a setting unit configured to set and hold key setting information associated with at least the particular key operation.

7. The information processing apparatus according to claim 1, wherein said display control unit causes said display unit to display a particular key candidate associated with a key operation accepted through the software key screen.

8. The information processing apparatus according to claim 1, further including:
a setting unit configured to changeably set and hold setting information that represents a method of the particular key operation.

9. A control method for an information processing apparatus for remotely operating a device connected thereto through a network, comprising:
a display control step of causing a display unit of the information processing apparatus to display a software key screen;
a key operation acceptance step of accepting a key operation performed on the software key screen and holding key operation information corresponding to the key operation;
a data conversion step of converting the key operation information into transmission data;
a communication step of transmitting the transmission data to the device through the network; and
a change step of changing display of software keys on the software key screen in a case where a particular key operation that causes the display unit to display a particular screen is accepted in said key operation acceptance step.

10. A non-transitory computer-readable storage medium storing a program to cause a computer to execute the control method as set forth in claim 9.
